(19) United States
(12) Patent Application Publication
(10) Pub. No.: US 2003/0066716 A1
(43) Pub. Date: Apr. 10, 2003

(54) Wheel brake of a golf cart

(76) Inventor: Chong-Yong Liu, Taichung (TW)

Correspondence Address: Chong-Yong Liu, 58, MA YUAN WEST ST., TAICHUNG, TW

(21) Appl. No.: 09/975,603

(22) Filed: Oct. 9, 2001

(51) Int. Cl. B62B 5/04

(52) U.S. Cl. 188/19; 188/68

(57) ABSTRACT

A wheel brake of a golf cart has a pedal plate, a positioning seat, a movable seat, a spring, a ring, an elastic bar, a bolt, a nut, and a base seat. The positioning seat engages with the movable seat. The positioning seat and the movable seat are disposed on the base seat. A pair of parallel triangular plates are disposed on the pedal plate. Each of the parallel triangular plates has a round aperture and an oblong aperture. The pedal plate is disposed on the positioning seat. The movable seat is inserted between the parallel triangular plates. The positioning seat has a pair of posts, a protruded block, a round hole, and a recess. The movable seat has a click block, an oblong hole, an inner channel having a triangular head and a curved end, and a slot to receive the spring. The bolt passes through the oblong aperture of each triangular plate and the oblong hole of the movable seat. The bolt engages with the nut. Each post is inserted through the corresponding round aperture of the triangular plate.

### BACKGROUND OF THE INVENTION

The present invention relates to a wheel brake of a golf cart. More particularly, the present invention relates to a wheel brake to brake a wheel of the golf cart.

A conventional wheel brake of a golf cart is operated by a hand of a user. However, the user often uses two hands to operate the conventional wheel brake of the golf cart carefully.

### SUMMARY OF THE INVENTION

An object of the present invention is to provide a wheel brake of a golf cart which is operated by a foot of a user easily.

Accordingly, a wheel brake of a golf cart comprises a pedal plate, a positioning seat, a movable seat, a spring, a ring, an elastic bar, a bolt, a nut, and a base seat. The positioning seat engages with the movable seat. The positioning seat and the movable seat are disposed on the base seat. A pair of parallel triangular plates are disposed on the pedal plate. Each of the parallel triangular plates has a round aperture and an oblong aperture. The pedal plate is disposed on the positioning seat. The movable seat is inserted between the parallel triangular plates. The positioning seat has a pair of posts, a protruded block, a round hole, and a recess. The movable seat has a click block, an oblong hole, an inner channel having a triangular head and a curved end, and a slot to receive the spring. The bolt passes through the oblong aperture of each triangular plate and the oblong hole of the movable seat. The bolt engages with the nut. Each post is inserted through the corresponding round aperture of the triangular plate. The elastic bar has a first end inserted in the inner channel of the movable seat and a second end inserted in the round hole of the positioning seat. The ring encloses the recess of the positioning seat to fasten the elastic bar and the positioning seat together.

### BRIEF DESCRIPTION OF THE DRAWINGS

FIG. 1 is a perspective assembly view of a wheel brake of a golf cart of a preferred embodiment in accordance with the present invention;

FIG. 2 is a perspective exploded view of a wheel brake of a golf cart of a preferred embodiment in accordance with the present invention;

FIG. 3 is a schematic view illustrating an application of a wheel brake of a golf cart of a preferred embodiment in accordance with the present invention;

FIG. 4 is an elevational schematic view illustrating a first operation of a wheel brake of a golf cart of a preferred embodiment in accordance with the present invention;

FIG. 5 is a bottom schematic view illustrating a first operation of a wheel brake of a golf cart of a preferred embodiment in accordance with the present invention;

FIG. 6 is an elevational schematic view illustrating a second operation of a wheel brake of a golf cart of a preferred embodiment in accordance with the present invention;

FIG. 7 is a bottom schematic view illustrating a second operation of a wheel brake of a golf cart of a preferred embodiment in accordance with the present invention;

FIG. 8 is an elevational schematic view illustrating a third operation of a wheel brake of a golf cart of a preferred embodiment in accordance with the present invention;

FIG. 9 is a bottom schematic view illustrating a third operation of a wheel brake of a golf cart of a preferred embodiment in accordance with the present invention;

FIG. 10 is an elevational schematic view illustrating a status of a wheel brake of a golf cart before the wheel brake of the golf cart is operated;

FIG. 11 is a bottom schematic view illustrating a status of a wheel brake of a golf cart before the wheel brake of the golf cart is operated; and

FIG. 12 is a schematic view illustrating an operation of a pedal plate of a preferred embodiment in accordance with the present invention.

### DETAILED DESCRIPTION OF THE INVENTION

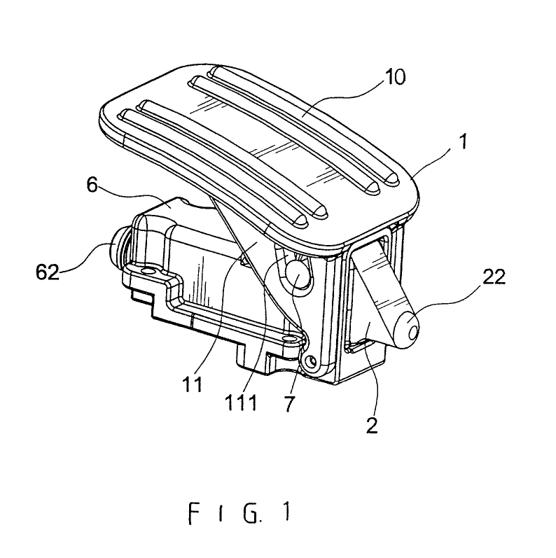

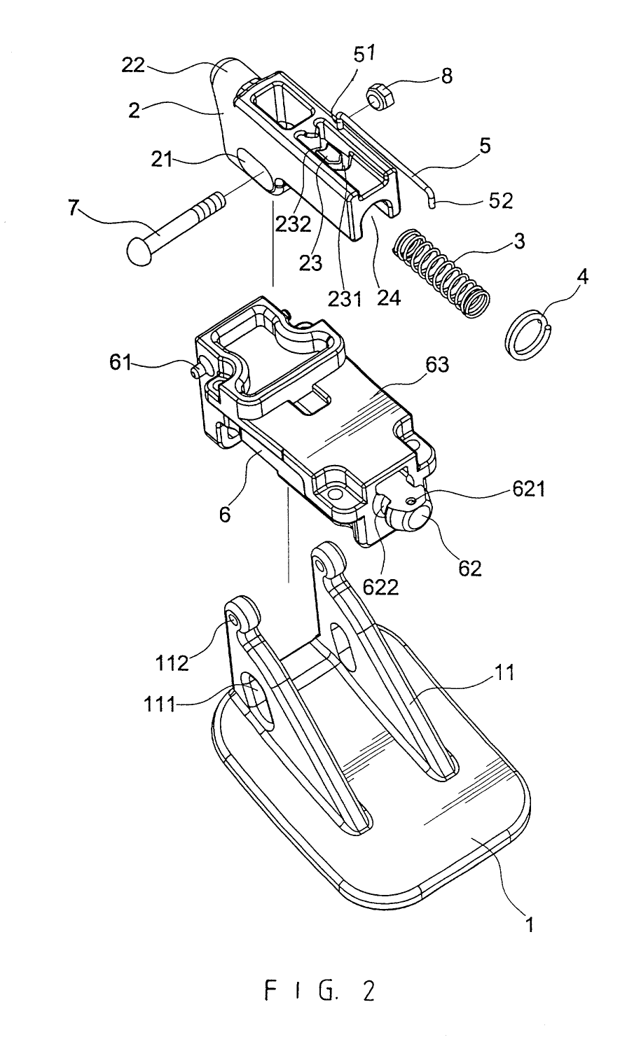

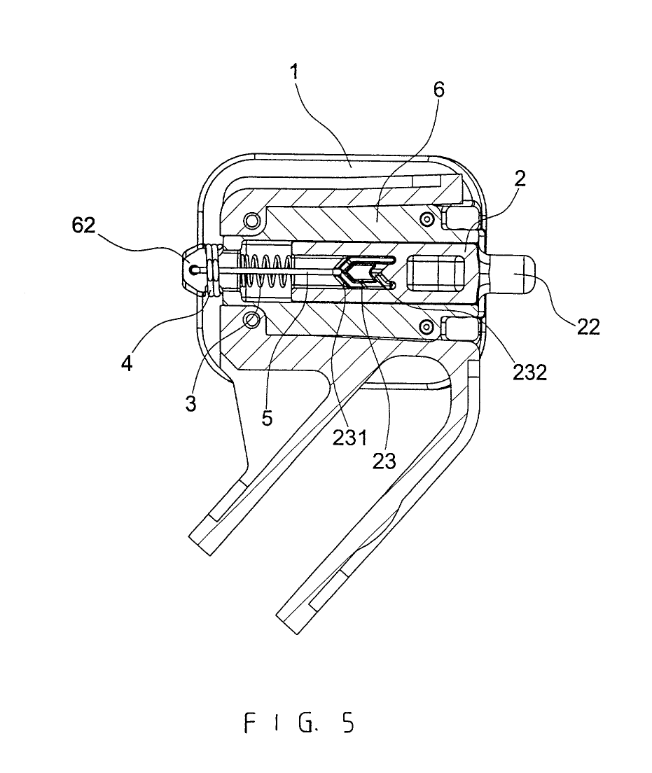

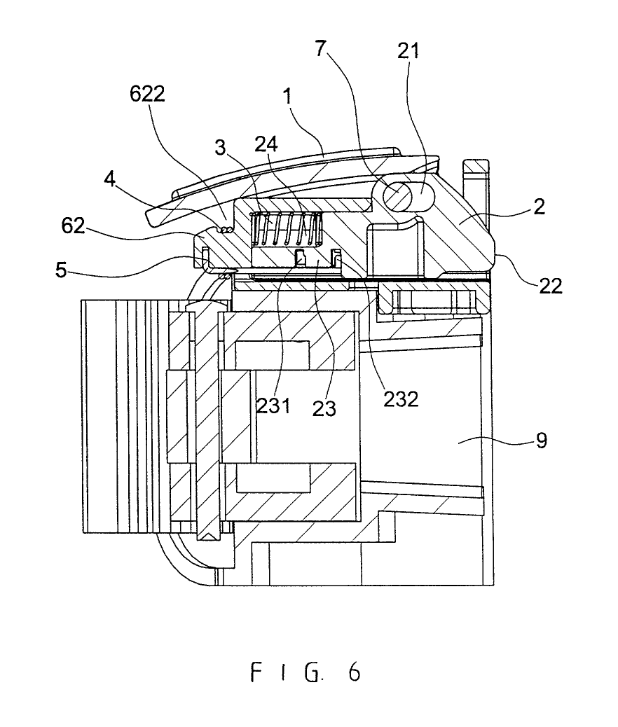

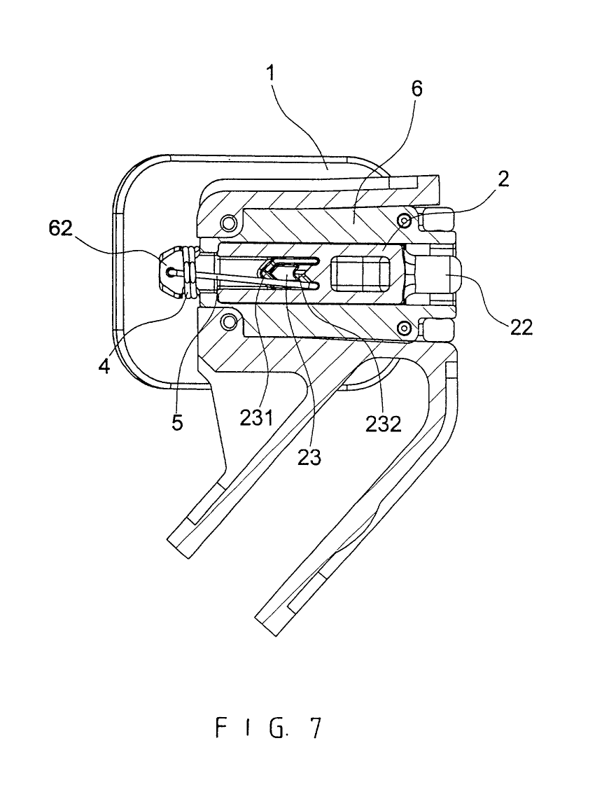

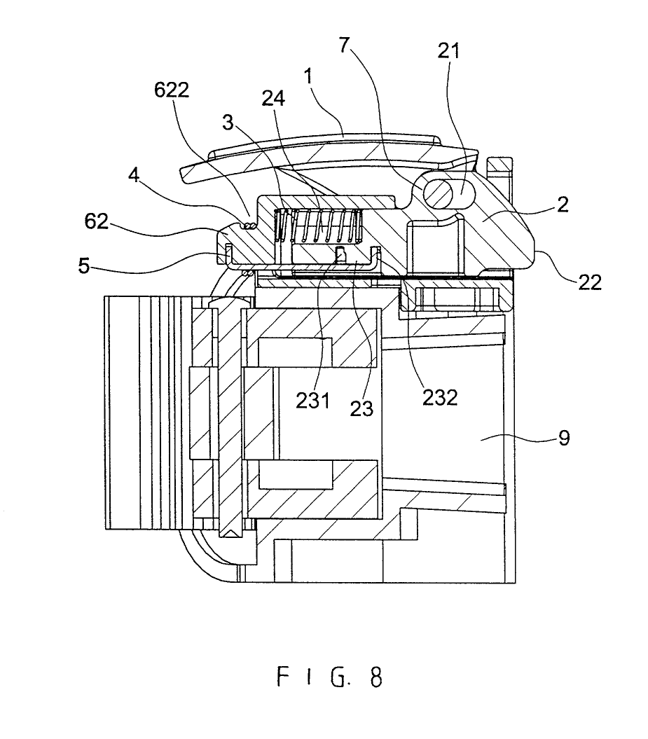

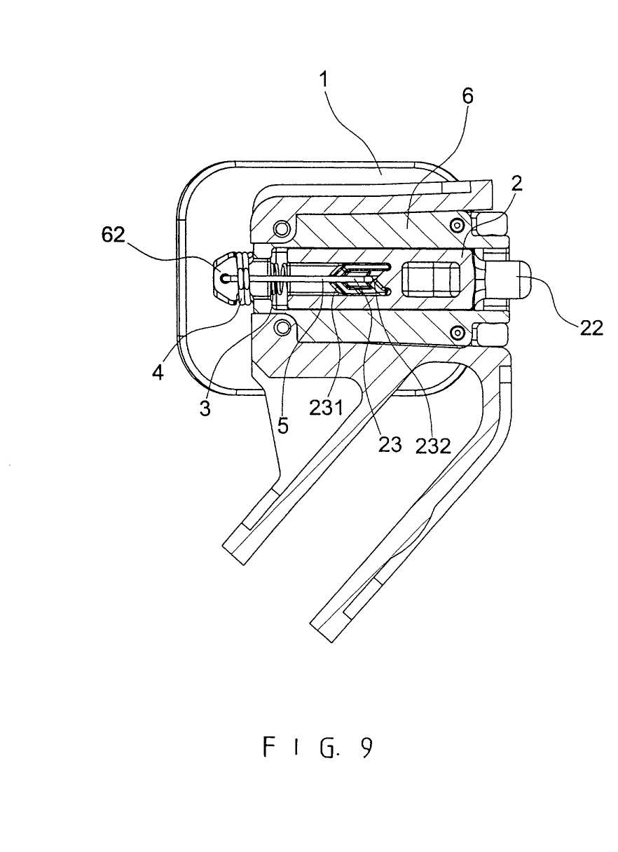

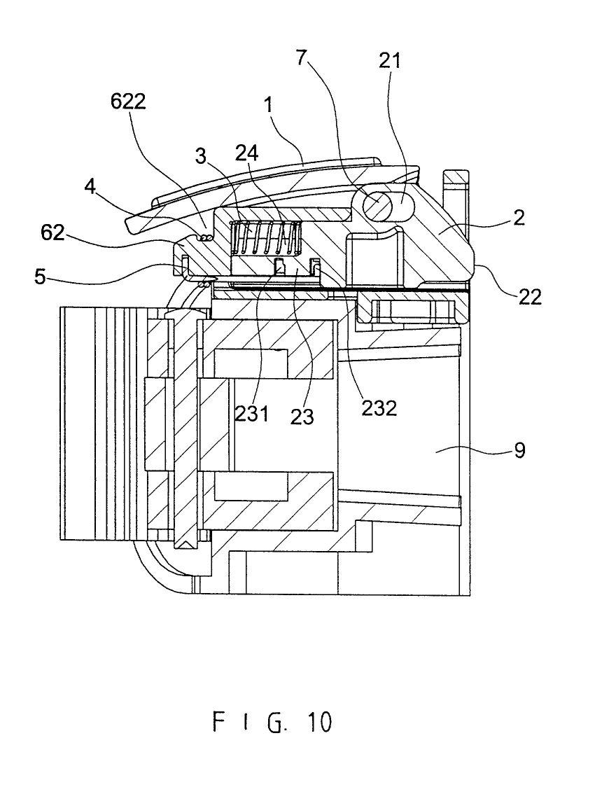

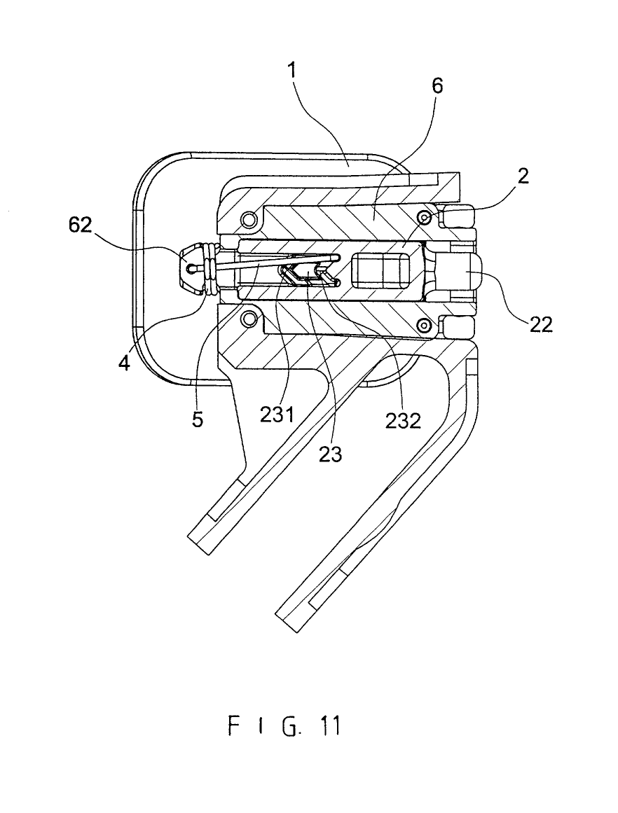

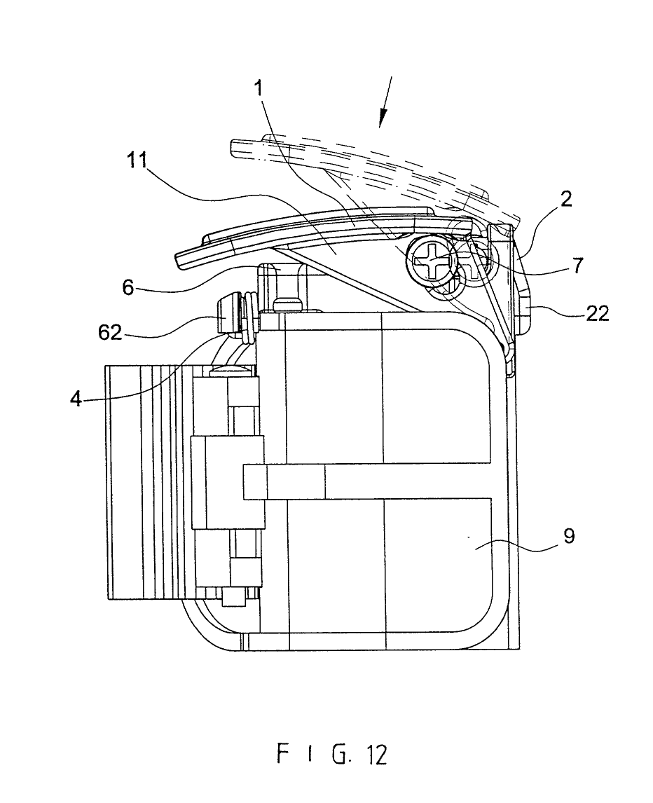

Referring to FIGS. 1 to 12, a wheel brake of a golf cart comprises a pedal plate 1, a positioning seat 6, a movable seat 2, a spring 3, a ring 4, an elastic bar 5, a bolt 7, a nut 8, and a base seat 9.

The pedal plate 1 has a plurality of protruded ribs 10.

The positioning seat 6 engages with the movable seat 2.

The positioning seat 6 and the movable seat 2 are disposed on the base seat 9.

A pair of parallel triangular plates 11 are disposed on the pedal plate 1.

Each of the parallel triangular plates 11 has a round aperture 112 and an oblong aperture 111.

The pedal plate 1 is disposed on the positioning seat 6.

The movable seat 2 is inserted between the parallel triangular plates 11.

The positioning seat 6 has a pair of posts 61, a protruded block 62, a flat face 63, a round hole 621, and a recess 622.

The movable seat 2 has a click block 22, an oblong hole 21, an inner channel 23 having a triangular head 231 and a curved end 232, and a slot 24 to receive the spring 3.

The bolt 7 passes through the oblong aperture 111 of each triangular plate 11 and the oblong hole 21 of the movable seat 2.

The bolt 7 engages with the nut 8.

Each post 61 is inserted through the corresponding round aperture 112 of the triangular plate 11.

The elastic bar 5 has a first end 51 inserted in the inner channel 23 of the movable seat 2 and a second end 52 inserted in the round hole 621 of the positioning seat 6.

The ring 4 encloses the recess 622 of the positioning seat 6 to fasten the elastic bar 5 and the positioning seat 6 together.

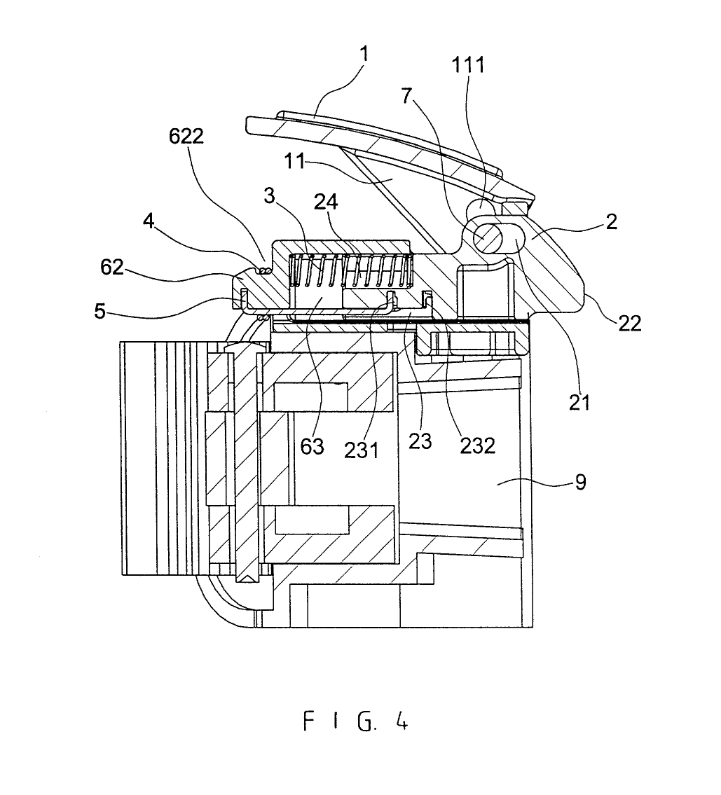

The first end 51 of the elastic bar 5 is moved between the triangular head 231 and the curved end 232 of the inner channel 23 (as shown in FIGS. 4 to 11) according to the operation of the pedal plate 1.

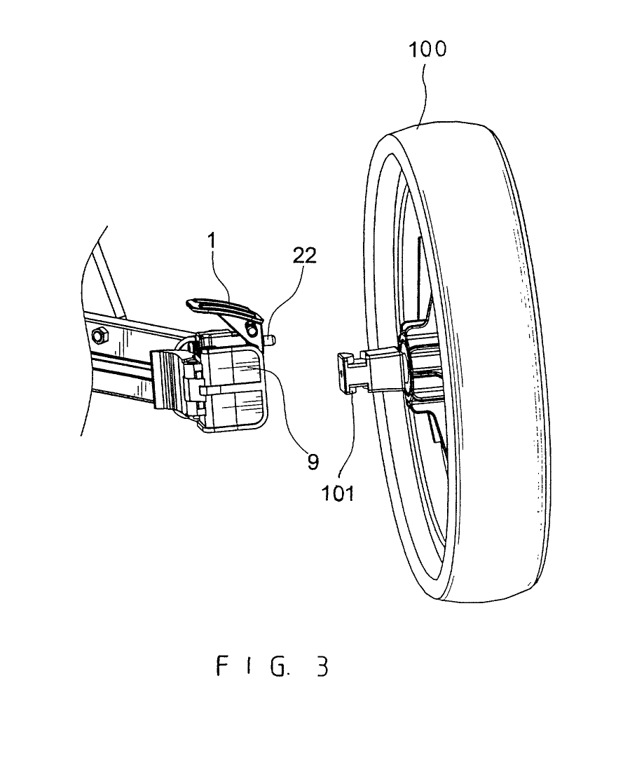

Referring to FIG. 3, a wheel 100 has a center shaft 101. The base seat 9 engages with the center shaft 101.

The invention is not limited to the above embodiment but various modification thereof may be made. Further, various changes in form and detail may be made without departing from the scope of the invention.

I claim:

1. A wheel brake of a golf cart comprises:
a pedal plate, a positioning seat, a movable seat, a spring, a ring, an elastic bar, a bolt, a nut, and a base seat,
the positioning seat engaging with the movable seat,
the positioning seat and the movable seat disposed on the base seat,
a pair of parallel triangular plates disposed on the pedal plate,
each of said parallel triangular plates having a round aperture and an oblong aperture,
the pedal plate disposed on the positioning seat,
the movable seat inserted between the parallel triangular plates,
the positioning seat having a pair of posts, a protruded block, a round hole, and a recess,
the movable seat having a click block, an oblong hole, an inner channel having a triangular head and a curved end, and a slot to receive the spring,
the bolt passing through the oblong aperture of each said triangular plate and the oblong hole of the movable seat,
the bolt engaging with the nut,
each said post inserted through the corresponding round aperture of the triangular plate,
the elastic bar having a first end inserted in the inner channel of the movable seat and a second end inserted in the round hole of the positioning seat, and
the ring enclosing the recess of the positioning seat to fasten the elastic bar and the positioning seat together.
